(19) United States
(12) Patent Application Publication
(10) Pub. No.: US 2016/0091610 A1
(43) Pub. Date: Mar. 31, 2016

(54) GPS TRACKING ARROW

(71) Applicant: Matthew Eggers, Herriman, UT (US)

(72) Inventor: Matthew Eggers, Herriman, UT (US)

(21) Appl. No.: 14/497,192

(22) Filed: Sep. 25, 2014

(51) Int. Cl. G01S 19/19

(52) U.S. Cl. CPC G01S 19/19

(57) ABSTRACT

A global positioning system (GPS) is disclosed for tracking prey wounded with an arrow during bowhunting excursions. The taught invention includes, in some embodiments, a cylindrical transmitter, power supply, and/or pressure sensor disposed in or to an arrow. Some embodiments recite a detachable GPS tracking system. Others recite an integrated system comprising the GPS tracking system, arrow and broadhead.

### BACKGROUND OF THE INVENTION

1. Field of the Invention

This invention relates to global positioning systems (GPS) and hunting implements, and more particularly relates to an arrow comprising a GPS receiver for use in bowhunting.

2. Description of the Related Art

Global positioning system (GPS) tracking systems are known in the art, including arrows comprising GPS tracking transcievers for tracking prey during bowhunts. However, the methods, systems and apparati taught in the prior art are cumbersome, eccentric, and negatively useability and the ballistics of an arrow in flight. Some variations of the prior art teach arrows comprising barbs and other sensors which protrude from an arrow shaft and none of the variations taught in the prior art are interchangeable with standardly manufactured arrows on the market (each requires specially made arrows and arrow shafts).

Typically, available GPS tracking systems for hunters constrain the hunter, particularly bowhunters, to a single model of arrow designed and manufactured primarily for its utility as a GPS transceiver, rather than with regard to its weight, tensile strength, flight characteristics and the like.

There is a need in the art for more efficient implements for tracking prey by bowhunters.

### SUMMARY OF THE INVENTION

From the foregoing discussion, it should be apparent that a need exists for a more efficient GPS tracking arrow. Beneficially, such an apparatus would overcome many of the difficulties with the prior art by providing an interchangeable GPS tracking system which does not suffer from the same defects with typify the prior art.

The present invention has been developed in response to the present state of the art, and in particular, in response to the problems and needs in the art that have not yet been fully solved by currently available apparati. Accordingly, the present invention has been developed to provide a

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is an elevational perspective view of a GPS tracking arrow in accordance with the present invention;

FIG. 2 is an elevational perspective view of a GPS tracking arrow in accordance with the present invention;

FIG. 3 is an elevational perspective view of a GPS tracking arrow in accordance with the present invention;

FIG. 4A is a lower perspective view of a GPS tracking arrow in accordance with the present invention; and

FIG. 4B is a lower perspective view of a GPS tracking arrow in accordance with the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

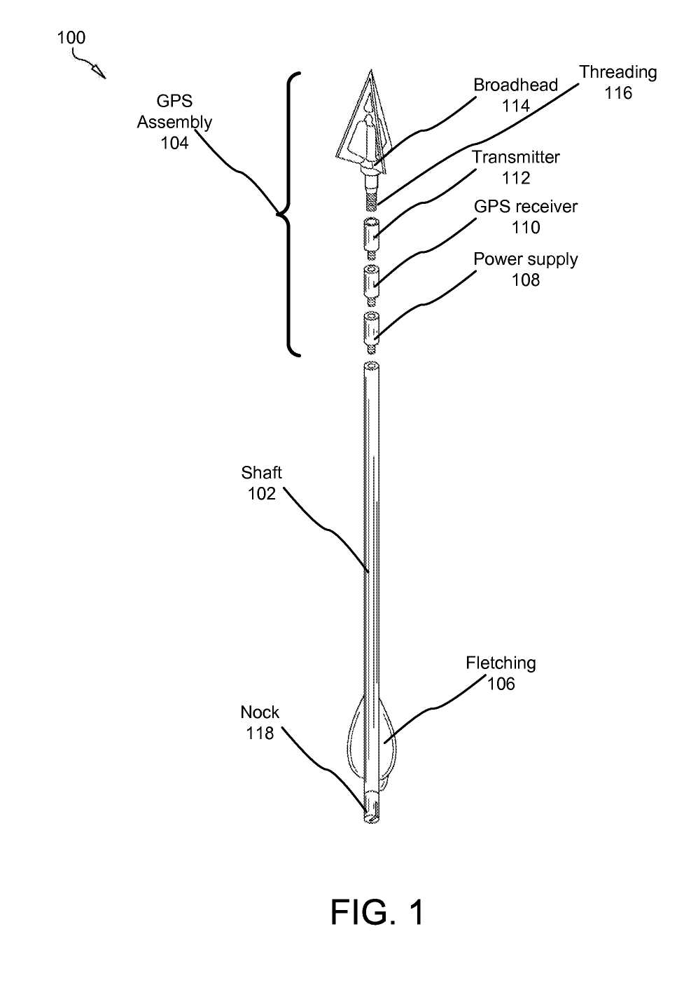

FIG. 1 is an elevational perspective view of a GPS tracking arrow 100 in accordance with the present invention. The GPS tracking arrow 100 comprises a shaft 102; a GPS assembly comprising a power supply 108, a GPS receiver 110, a transmitter 112 and a broadhead 114 having threading 116; and fletchings 106.

The arrow 100 depicted in FIG. 1 is enabled to transmit a GPS positioning signal data to a handheld transceiver in the possession of a hunter who has hit prey with the arrow 100. The hunter uses positioning data received on the handheld transceiver to track and/or locate prey wounded with the arrow 100.

In various embodiments described further below, the GPS assembly 104 is housed within the arrow shaft 102 or it 104 or its 104 components are threaded detachably to a distal end of the shaft 102 and exposed exteriorally.

Each of the components 108-116 in the shown embodiment comprise axially threadable and elongated cylindrical members of the same diameter as the shaft 102. The components 108-116 may be manufactured to standard specifications, including standard diameter specifications for existing arrows or shafts 102 on the market.

In the shown embodiment, the tip of the shaft 102 (i.e. the distal end) is interiorally threaded to receive threaded components of a broadhead 114 or, in accordance with the present invention, the GPS assembly 104. In the shown embodiment, each of these components 108-116, are stackably and detachably threaded to the shaft 102 then one to another. The components 108-116 may be in electrical connectivity with one another via the threading interconnecting each component 108-116.

Some variation of the present invention comprise a pressure sensor or piezoelectric plate, threadably connected between the broadhead 114 and the transmitter 112, or between the broadhead 114 and any of the other components 108-116 such that the sensor is activated when the arrow 100 hits or strikes a dense object, including flesh or bone.

In place of a transmitter 112 and a GPS receiver 110, the arrow 100 may include merely a transceiver in some embodiments. The components 108-116 of the GPS assembly 104 may be stacked in any order, shaped in any fashion, and inserted into the shaft 102 permanently or detachably.

The transmitter 112 and/or GPS receiver 110 may comprise a GPS microchip and GPS circuitry adapted for GPS satellite positioning of the location of the arrow 100.

A handheld transceiver (not shown) comprising a GUI (graphical user interface) display is configured to receive GPS satellite data from the arrow 100 and display positioning information on the GUI.

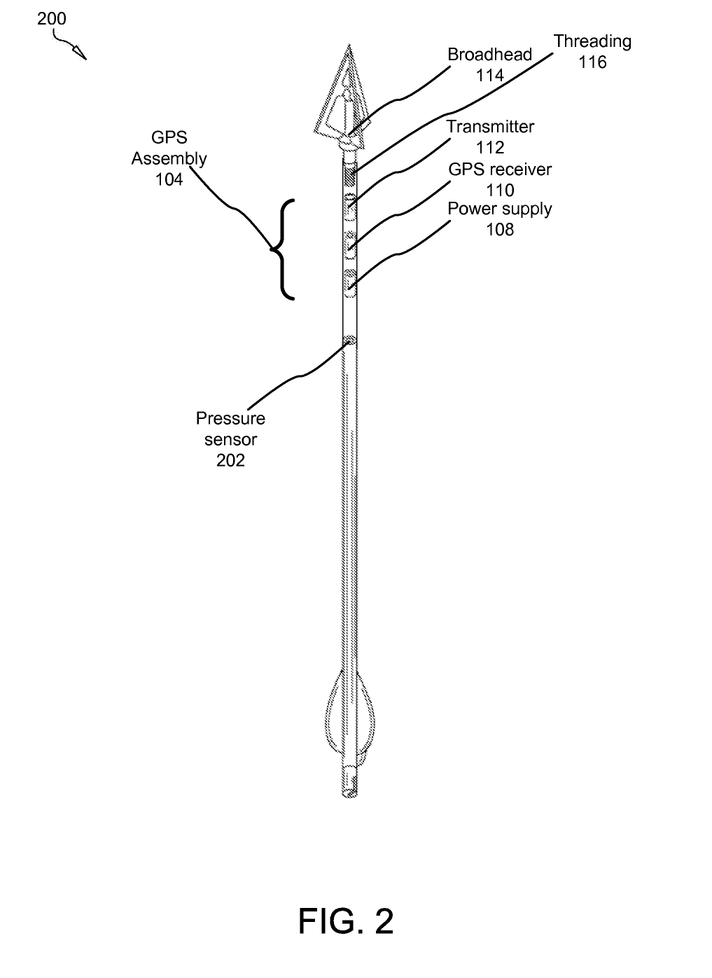

FIG. 2 is an elevational perspective view of a GPS tracking arrow 200 in accordance with the present invention. The arrow 200 comprises a GPS assembly 104 comprising a power supply 108, a GPS receiver 110, a transmitter 112 and threading 116, and a pressure sensor 202.

The pressure sensor 202 may be disposed above or below the GPS assembly 104 (i.e. the pressure sensor 202 may be disposed toward the distal end or proximal end of the shaft 102, adjacent to the GPS assembly 104.

The arrow 200 may further comprise a polymeric or metallic insert enabled to prevent movement of the GPS receiver 104 within the shaft 102 along the shaft's 102 longitudinal axis.

In the shown embodiment, the components 108-116 are interiorally enabled within the shaft 102.

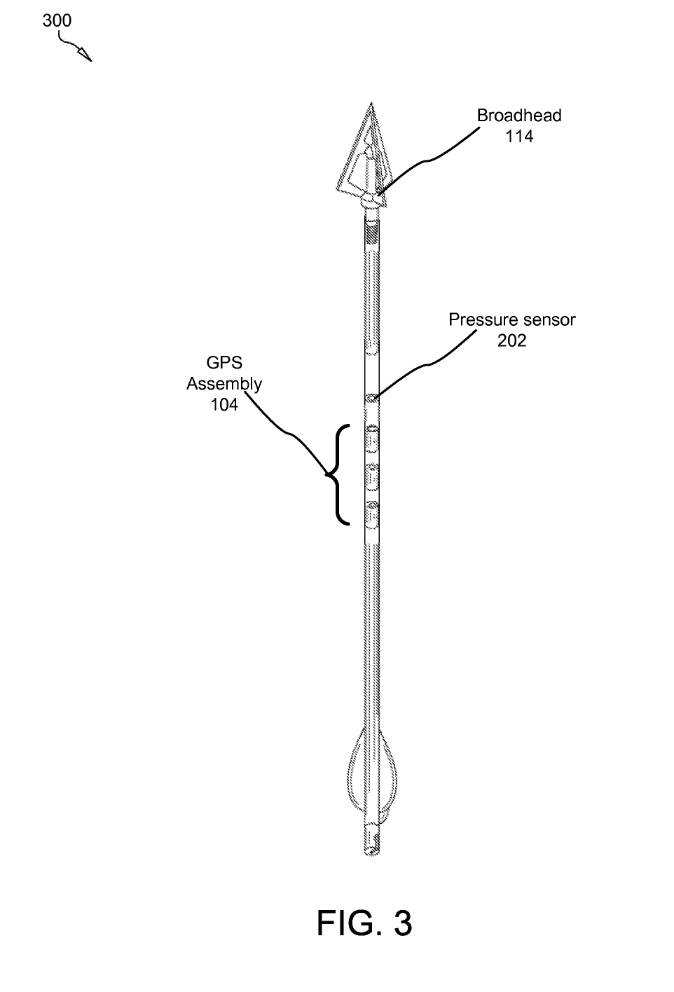

FIG. 3 is an elevational perspective view of a GPS tracking arrow 300 in accordance with the present invention. The arrow 300 comprises a GPS assembly 104, a pressure sensor 202 and a broadhead 114.

As shown, the GPS assembly 104 may be housed, received or disposed midway across the longitudinal axis of the shaft 102 such that the arrow 300 remains balanced in flight instead of top-heavy. The GPS assembly 104 may be disposed at or on the center of gravity of the arrow 300 alone, or the arrow 300 affixed to the broadhead 114.

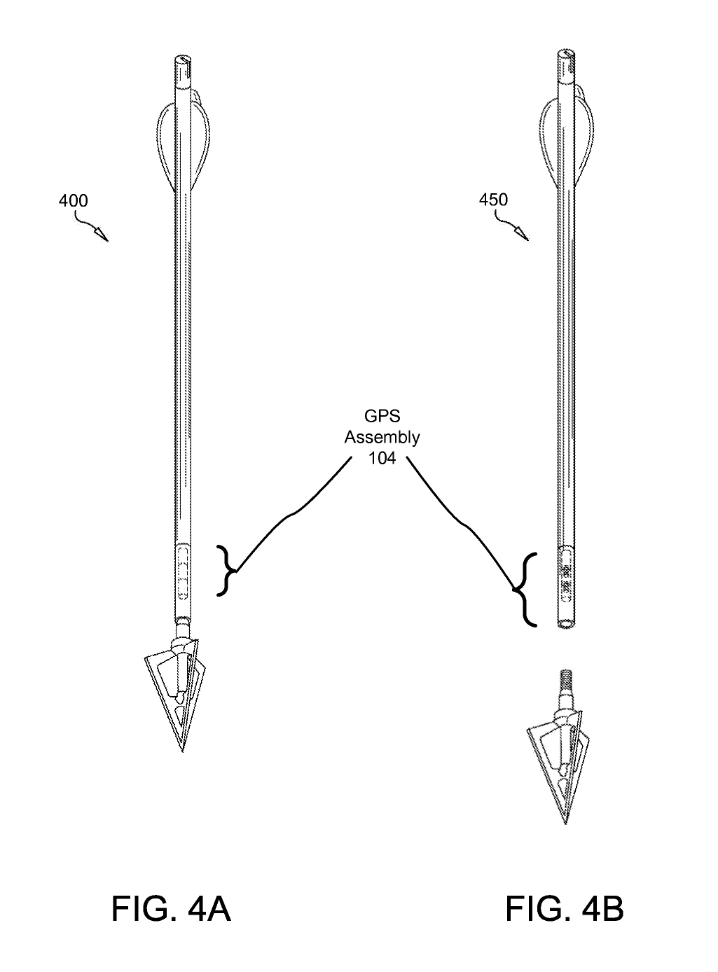

FIG. 4A is a lower perspective view of a GPS tracking arrow 400 in accordance with the present invention. The arrow 400 comprises a GPS assembly 104.

In the shown embodiments, the GPS assembly 104 is disposed interiorally to the arrow 400 toward the distal end of the arrow 400.

FIG. 4B is a lower perspective view of a GPS tracking arrow 450 in accordance with the present invention. The arrow 450 comprises a GPS assembly 104.

The GPS assembly 104 in the shown embodiment comprises only two components 108-116 of the three shown above.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A global positioning system (GPS) tracking apparatus for tracking wounded prey, the apparatus comprising:
an axially-elongated power supply threadable to an arrow shaft;
an axially-elongated GPS receiver threadable to an arrow shaft, the GPS receiver in electrically connectivity with the power supply; and
a broadhead threadably connected to one of the arrow shaft and the GPS receiver;
wherein the GPS tracking apparatus is detachably affixed to the arrow.

2. The GPS broadhead of claim 1, further comprising an axially-elongated GPS transmitter threadable to one of an arrow shaft and the GPS receiver.

3. The GPS broadhead of claim 1, wherein the broadhead is permanently affixed to the GPS receiver.

4. A global positioning system (GPS) arrow for tracking wounded prey, the arrow comprising:
a hollow cylindrical shaft for receiving a GPS assembly, the GPS assembly comprising:
an axially-elongated power supply; and
an axially-elongated GPS receiver;
wherein the GPS assembly is disposed midway between a distal end and a proximal end of the shaft.

5. The GPS broadhead of claim 3, wherein the GPS assembly further comprising an axially-elongated GPS transmitter.

6. The GPS broadhead of claim 3, wherein the GPS assembly is disposed over a center of gravity of the arrow.
